(19) United States
(12) Patent Application Publication
(10) Pub. No.: US 2010/0284246 A1
(43) Pub. Date: Nov. 11, 2010

(54) SEISMOGRAPHY SYSTEM

(76) Inventors: Conor Keegan, Ste Foy De Peyrolieres (FR); Elio Vecchione, Toulouse (FR)

Correspondence Address: Perman & Green, LLP, 99 Hawley Lane, Stratford, CT, 06614, US

(21) Appl. No.: 12/446,005

(22) PCT Filed: Oct. 23, 2007
(86) PCT No.: PCT/IB07/03423

§ 371 Date: Jul. 28, 2010

(30) Foreign Application Priority Data
Oct. 23, 2006 (GB) 0621015.7

(51) Int. Cl. G01V 1/28; G01S 19/42; G01S 19/24

(52) U.S. Cl. 367/14; 342/357.25; 342/357.63

(57) ABSTRACT

The present invention provides a method and apparatus for providing simplified seismological surveys with increased accuracy and ease of use. The present invention uses data received from satellite positioning systems to obtain time and position information. The information is used to determine transmission times of pressure waves between a seismic source and a seismic sensor.

The present invention relates to seismography and seismography systems, particularly those used for surveying and analysing geological structures.

Seismography is based on transmitting pressure waves from a source, and comparing the time of arrival of the waves at a network of distributed sensors. The sensors are connected via cables to a seismograph, which typically starts recording traces from all sensors in parallel when the source is activated. The relative signal arrival times are in fact measured and recorded at the seismograph inputs connected to each sensor.

The time taken for a wave to be received by a given sensor depends on its distance from the source, as well as the composition, state and features of the medium through which the wave travels. Comparing the times taken for the waves to reach the different sensors enables one (using the appropriate processing) to deduce the subsurface composition and features.

Seismography does not currently measure the absolute propagation time of the seismic waves through the medium with a high degree of accuracy, but rather compares the relative arrival times of the signal at the array of distributed sensors. The potential accuracy of existing systems is therefore limited by the uncertainty of a number of factors. This includes the uncertainty in the time taken from triggering the source to the pressure wave starting to propagate away from the source, the accuracy of the sensors, timing errors introduced in transmitting signals via cables to the seismograph, and the signal conversion and synchronisation/timing accuracy of the seismograph. These uncertainties will add up and their cumulative effect will reduce the achievable resolution and accuracy of the survey.

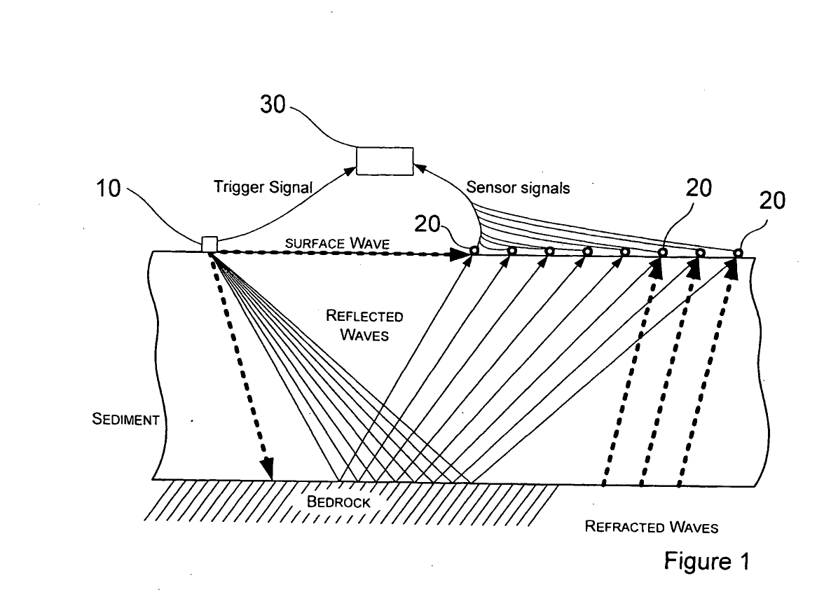

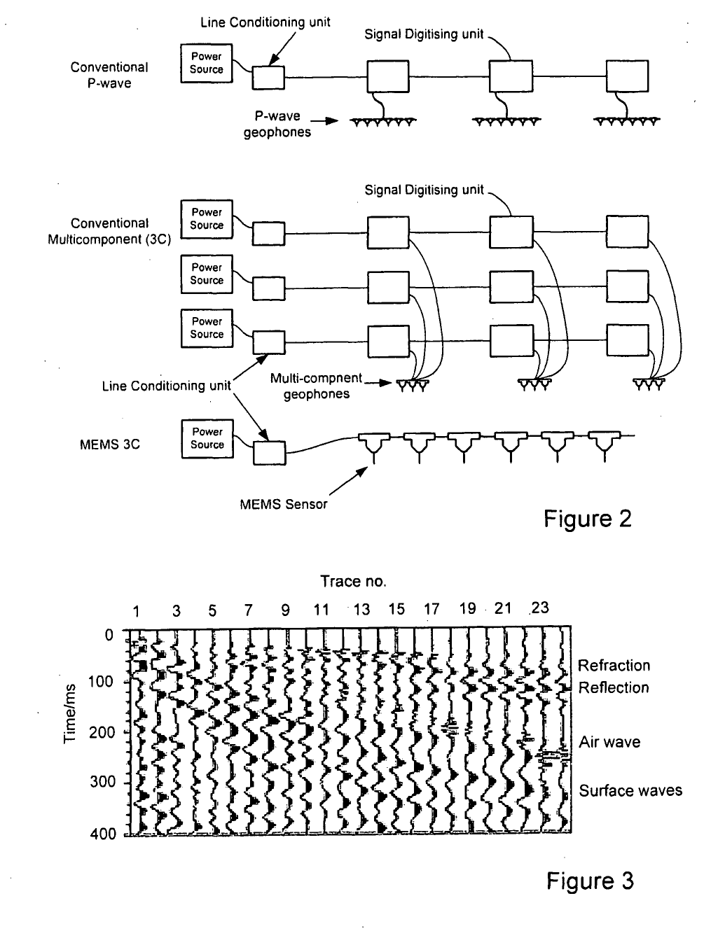

Existing systems are generally used with a source 10 connected to an array of sensors 20, as shown in FIGS. 1 and 2. These are typically all connected together by cables to allow the electrical signals generated to be communicated to the seismograph 40 recording the data. The cables need to have defined characteristics so that the delay introduced by them can be taken into account. This typically means having cables with fixed length. These cables are used in harsh environments and are spread over considerable distances and so tend to be long and heavy, and frequently need repair. At the same time they have strict requirements in terms of the continuity of their transmission properties.

Wireless systems have been proposed to remove the need for cables. Although these systems do reduce operational weight and reliability constraints, they still introduce variable delays in the transmission of signals to the seismograph.

It is an aim of the present invention to provide a seismography system to accurately measure the propagation times of seismic waves using an accurate and absolute reference timing signal. These reference timing signals are preferably provided by timing signals from a satellite positioning system reference such as Global Navigation Satellite Systems (GNSS), e.g. GPS, GLONASS, Galileo. Using the GNSS signals in both sources and sensors allows direct measurement of the absolute pressure wave propagation times between sources and sensors, with an accuracy determined solely by the source and sensor measurement accuracy and the accuracy of the time reference source.

Therefore according to the present invention there is provided a seismographic sensor comprising: a seismic transducer for receiving seismic signals to produce seismic signal data; a time signal receiver for obtaining signals comprising time information; and signal processing means arranged to store said seismic signal data along with time information corresponding to the time at which the seismic signals are received.

The time information is preferably based upon an absolute global time reference. This ensures that all the measurements are made according to the same accurate and absolute time reference.

The time signal receiver is preferably arranged to receive satellite positioning signals and to extract the time information from the received signals. Satellite positioning signals such as GPS include accurate clocks which are synchronised and calibrated to provide an extremely accurate and reliable absolute time reference. This time reference can be received and accurately reproduced by satellite receivers such as those using the GNSS systems, such as GPS.

Whilst satellite positioning signals provide a convenient source of accurate timing signals, accurate time signals could be generated from terrestrial sources or even locally with suitable calibration and so the invention is not intended to be limited in this respect.

The use of position information such as that provided when using satellite based positioning data, allows the added benefit of being able to determine the position of the sensor. This can be used in conjunction with the said seismic signal data to perform seismographic surveys and processing of the seismic signal and time data.

Preferably, the seismographic sensor comprises a communicator arranged to transmit the seismic signal data and time information to devices in a remote location or to a data storage device which is connected directly to the sensor. This allows the gathered data to be transferred to a processing device for storage, formatting, processing and analysis of the data.

The seismic transducer may be any suitable device as known in the art such as analogue coil based geophones or 3C MEMS sensors for ground based measurements or such as hydrophones for maritime applications.

The time signal receiver may be located remotely from the seismic transducer. This allows the receiver to be provided at a convenient location for receiving signals such as satellite signals which may not propagate through mediums such as water or rock; and the seismic sensor to be located underground, such as in a borehole, or under water. The receiver is then positioned on the surface to allow good reception of the timing signals.

The seismic sensor and recording apparatus are preferably collocated to avoid delays in transmission of the signals. The connection between the receiver for the timing signal and the data recording device is preferably an optical fibre link. This provides a link with very low variations in transmission delay. In this way a fixed delay will be introduced in data processing to take into account the transmission delay between the time signal receiver and the seismic transducer and recording device.

The present invention also provides a seismography signal source comprising: a seismic generator for generating seismic signals in a medium; a time signal receiver for obtaining signals comprising time information; and signal processing means arranged to store time information corresponding to the time at which the seismic signals were generated.

As with the sensor, it is preferable for a record of the transmitted seismic signals and their components to be stored. Again, it is desirable if the time information is related to an absolute global time reference, particularly those obtained from received satellite positioning signals.

Preferably, the location of the source is also determined using the received satellite positioning signals and that information stored with said seismic signal data.

Again, the information collected at the source can be communicated to a remote location or to a storage device connectable to the source to allow the collected data to be processed.

The seismic generator may be any number of devices which are known in the art such as a thumper, Vibroseis generator or an airgun. Preferably, the device can be electronically actuated to allow programmable initiation times or frequencies. However, this is not essential since the actuation of the source device can be accurately recorded in time and this can be compared to the accurate time stamped recordings of the sensed signals.

Similar to the sensor, the receiver for the timing signals at the source may be located remotely from the seismic generator. This allows the seismic generator to be positioned underground or under water:

The present invention further provides a seismography data processor comprising: a seismic information receiver arranged to receive seismic data from each of a plurality of seismography devices including at least one seismic source and one seismic sensor; a correlator for extracting time information associated with each set of seismic data and correlating all the sets of data with each other using said extracted time information.

Preferably the correlator is arranged to generate and output correlated seismic signal data sets in a conventional format for further processing. This allows the present invention to process the time stamped data from source and sensor to provide data which is in a format similar to existing seismic survey data. This allows the existing processing and analysis tools to be applied with them having to be modified. As these tools are often highly complex software or hardware, this is highly desirable.

The correlator may also make use of the position data to identify and preferably remove any redundant or anomalous data.

The sensor and source mentioned above may be used in a combined system, preferably with the data gathering and processing function to provide complete formatted seismic survey data. The system may comprise a single sensor and source or multiple sensors and/or multiple sources. Equally, the data collected by one sensor operated in multiple locations can be used.

Additionally, the present invention provides a method of collecting seismic survey data comprising: providing, at least at a first location, a seismic signal source including a receiver for receiving time information; controlling said seismic signal source to generate one or more seismic signals and recording the timing of said seismic signals using said time information; providing, at least at a second location, a seismic signal detector including a receiver for receiving time information; obtaining the recorded seismic signals and time information from said seismic signal source; obtaining from said seismic signal detector, data relating to received seismic signals which are time stamped using said time information; correlating the recorded seismic signals and time information with said time stamped received seismic signal data to provide said seismic survey data.

The present invention will now be described in detail, by way of example, with reference to the attached drawings, in which:

FIG. 1 is a diagram showing the principles of seismography;

FIG. 2 is a diagram showing the layout of a conventional seismography array;

FIG. 3 shows a typical seismography trace;

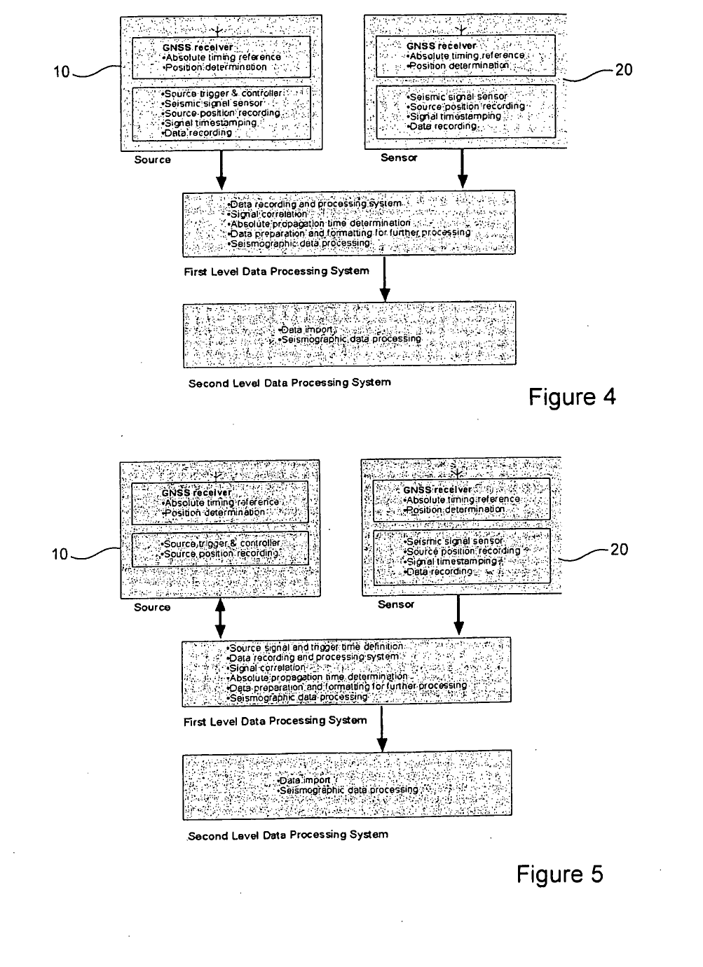

FIG. 4 shows schematically the main components of a GNSS based seismography system having a source with a sensor monitoring the seismic output;

FIG. 5 shows schematically the main components of a GNSS based seismography system having a source with a sensor monitoring the trigger signal;

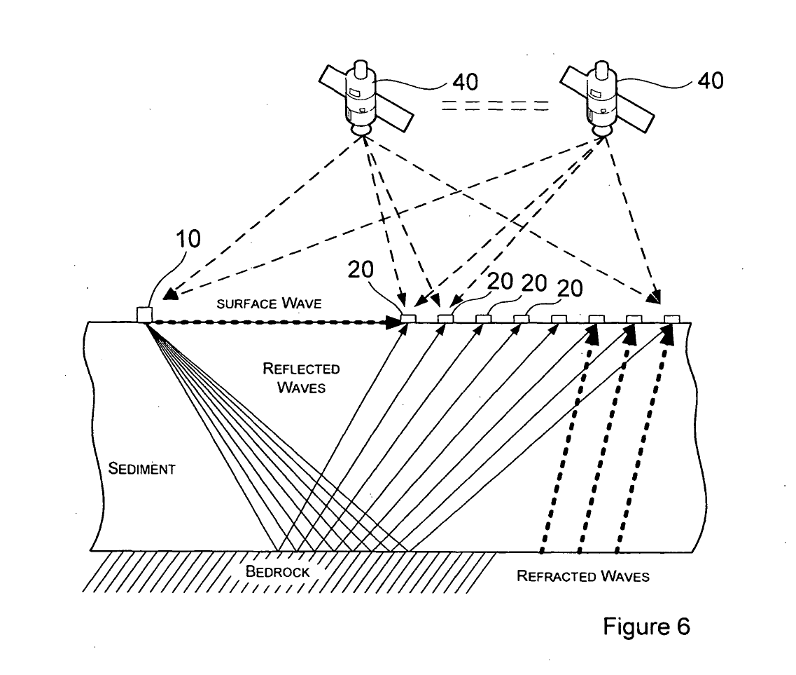

FIG. 6 shows one arrangement for a seismic survey using the present invention; and

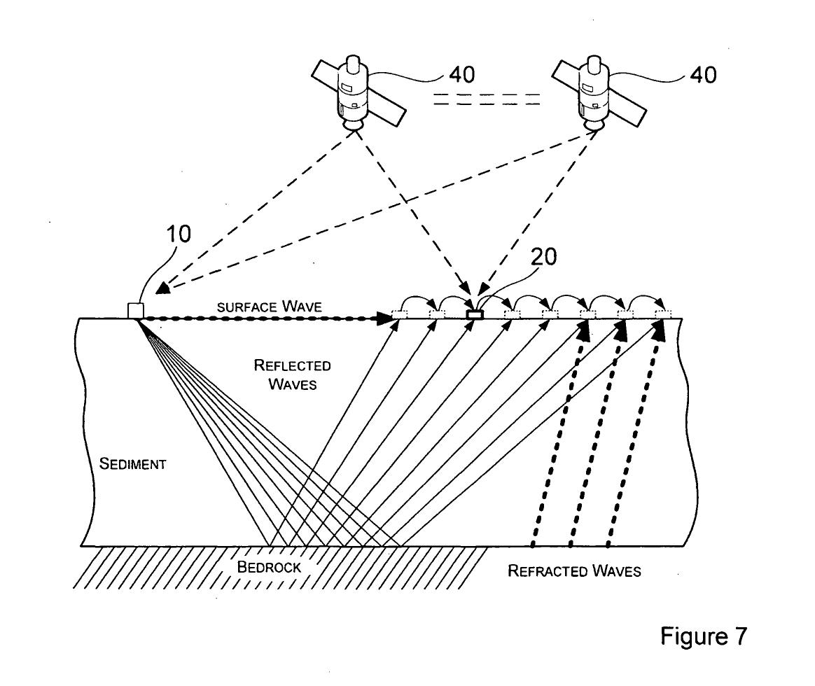

FIG. 7 shows another arrangement for a seismic survey using the present invention.

FIG. 1 shows the general principles of current seismography. During a seismographic survey, a source 10 of pressure or vibration is used to provide waves which propagate through the rock and soil or even water. The pressure waves are transmitted from the source through the medium to an array of sensors 20. The source 10 can be for example an explosion, a hammer striking a plate, an air gun, or more sophisticated systems such as pseudo-random impacts or swept-frequency signals. The sensors 20 of the array are connected via cables or radio links to a seismograph 30, which records traces from all sensors in parallel. The initiation of the source 10 triggers the seismograph 30 to start recording ready for the arrival of the signals from the sensors 20. The arrival times of the waves at the network of sensors is compared; or to be more accurate, the arrival times of the sensor signals at the seismograph are compared.

The time taken for a wave to be received by a given sensor depends on its distance from the source, as well as the composition, state and features of the media through which the wave travels. Comparing the times taken for the waves to reach the different sensors enables one (using the appropriate processing) to deduce the subsurface composition and features. The waves travel from the source to the sensors taking a number of routes. For example, the waves can travel through the air, along the surface (Surface Wave), or pass through the media. Signals passing through the media can be reflected from subsurface interfaces to the sensors (Reflected Wave), or be refracted along these interfaces and then pass back up to the sensors (Refracted Wave). There may be multiple reflections and refractions between interfaces. Each received wave will have a different travel time.

There are several array configurations in current art depending on the survey requirements and the technology chosen. Examples are shown in FIG. 2. These range from simple linear arrays for 2D seismography to rectangular arrays or linear arrays of 3 component (3C) sensors that allow three dimensional seismography. Off-shore seismography uses similar principles, where the arrays are embedded in streamers towed behind survey ships. The present invention can be used in all of these configurations.

In the simplest time-based processing case, the received signals are pre-processed in a similar fashion to that shown in FIG. 3. Each trace represents the signals received at a given sensor. In fact, since the sensors are all connected via cables or a radio link to a central seismograph, the trace actually represents the time at which each sensor signal is recorded by the seismograph.

When using analogue sensors, the time to transfer an analogue signal to the seismograph, perform analogue to digital conversion and store the signal can add a considerable degree of uncertainty to the real arrival time of the signals at the sensors. Digital sensors overcome some of these problems by performing analogue to digital (A/D) conversion of the received seismic wave signals in the sensor itself and transferring the resulting digital signal by cable or radio link to the seismograph. However, the problem remains that the digital signals are all transferred to a central seismograph where they are synchronised relative to each other; this introduces a potential relative timing error between signals, and does not provide any absolute timing information on the signal arrival times at the sensors. Global Navigation Satellite System (GNSS) satellites broadcast very precise timing information. This information can be used by a GNSS receiver to determine, for example, GPS Time or an estimate of UTC based on GPS Time. In particular, it can drive an internal clock that allows extremely accurate absolute time-stamping of received data.

In an embodiment of the present invention a GNSS receiver is incorporated into a seismographic sensor. This allows the accurate time reference to be used to time-stamp received seismic wave signals and their components in the sensor itself. The absolute timing information derived from the GNSS timing information can then be used to identify the absolute time of receipt of the seismic signals. The recorded data can then be compared with other data recorded and also relative to the source signal which can also be provided with an accurate time reference to record the timing of the source signal.

The accuracy of the signal time-stamping will depend on the absolute time-stamp accuracy, sensor signal sampling rate and accuracy of the sensor's A/D converter. Sensor position data will also be available via the GNSS receiver, and the time-stamped data plus sensor position information can be stored in the sensor or transferred to a bulk recording medium via cable/wireless/fibre-optic connections for further processing. Since the data is recorded with an absolute time stamp, this transfer can be in real time, shortly after the sampling or at any time later after the sensors are collected up and returned to a data processing facility.

Data recording in GNSS timing equipped sensors can be initiated either manually, via a trigger signal (as in existing systems), or at pre-programmed times, using the derived timing information. The latter alternative allows a cable-free synchronisation with a GNSS timing equipped source, which can be programmed to trigger the source at a given time. In this way, a sensor can be set up and left ready to record a source signal at a later point in time. The sensors may be simply left monitoring and recording all seismic signals and appropriate time stamping then for correlation with generated source signals later on.

Alternatively, the sensors may be limited to the recording of all signals that exceed a defined threshold. This can be used to avoid the need for triggering of the data recording. All data that exceed the threshold level can be time stamped and transferred or stored for further processing.

The arrangement of FIG. 4 will now be described in more detail. The sensor unit 20 used in this arrangement will include a GNSS receiver to obtain an accurate and absolute time reference. The GNSS receiver may also be used to obtain positional information to identify where the sensor is located. The sensor unit 20 also includes seismic sensing equipment and data recordal equipment. The seismic sensing equipment will be well known to the skilled man and is not described here in detail. The data recording equipment takes the signal from the seismic sensing equipment and records this information along with the corresponding time stamp information and possibly the determined position information. The data may be recorded and stored locally within the sensor, or transmitted to another device or location by wired or wireless methods.

The embodiment of FIG. 4 also incorporates a GNSS receiver in the seismographic source 10. The embodiment also equips the source with a seismographic sensor that detects, time-stamps and records the transmitted signals and their components.

The system of FIG. 4 processes the received data by collecting the data from the source and the sensors used (there may only be one sensor). The signals collected for each source signal are correlated with the signals received by the sensor in a first level data processing step, based on the characteristics of the signals and their components, the timing data and possibly the sensor locations.

The first level data processing step is to calculate the signal propagation time based on the time difference between the transmitted and received signals.

Each calculated propagation time will be associated with a source—sensor pair, whose positions can be determined either externally or recovered directly using GPS position information stored in the stored data. These propagation times may be used to determine subsurface composition directly, using the absolute propagation times. Alternatively or in addition, variations in subsurface composition may be monitored over a period of time by monitoring variations in absolute propagation times over the same period of time.

A second level data processing step can be introduced to generate traditional formattted seismographic data, showing the difference in relative arrival times at the different sensor positions.

This allows the formatted data to then be further analysed in a third level data processing step, for example using traditional seismic data analysis techniques. Either or both of these data processing steps may be carried out in the field, for example using a portable computer, or at a central processing facility. Typically the third level data processing will require significant computational power and so is not carried out in the field. By providing data in a standardised format, it may be combined with other data and processed using standard techniques.

There are two possible ways to store the signals transmitted by the source. Either the transmitted signals are measured directly using a sensor, as described above; or the signals to be transmitted can be defined a priori, and their transmission triggered manually or at a pre-defined time. In this case, only the trigger signals will be time-stamped; the signal that is actually transmitted is assumed to be transmitted perfectly at a known time after the corresponding trigger signals. In this way, the theoretically transmitted signal can be derived for reference to the signals received by the sensors 20.

FIG. 5 shows an embodiment of the latter possibility, where a GNSS receiver is also included in the seismographic source 10. This allows the time-stamping of the trigger signals used to generate the transmitted seismic wave signals and their components with absolute timing information derived from the GNSS timing information. The trigger signals are time-stamped and either stored locally or transmitted to a remote receiver by wired or wireless methods.

The processing system will now produce the corresponding “transmitted” signals and timestamp them according to the trigger signal timestamp and the assumed delay between the trigger signal and the signal transmission. These signals will then be correlated with the received signals.

This embodiment assumes that there is a fixed delay between the initiation of the source by the trigger signal and the beginning of the propagating wave leaving the source. For example in a system which uses a mechanical impact such as a hammer striking a plate, there will be a delay from the release of the hammer to it striking the plate. This is an extreme case but other systems will have corresponding delays. This technique is less accurate but does not require a sensor at the source to detect the wave generated. The accuracy here depends on the triggering accuracy of the source with respect to the defined trigger times. This embodiment could be used with electronically driven sources. Conventional explosive detonations are neither precise enough nor repeatable enough to provide any useful degree of accuracy.

In both of the above arrangements, the source can be initiated manually, or programmed to transmit at defined periods or according to a defined schedule.

The arrangements shown in FIGS. 4 and 5 perform the first level processing functions in a separate field unit, and transfer the results to a further off-site unit for further storage and processing. However, the processing functions listed above can be physically implemented in and distributed between the sources, sensors or separate processing units.

In the case of separate processing units, time-stamped data and position information will be transferred from sources and sensors to the processing units via cable, wireless, fibre-optic connections or storage medium. Real-time processing on-site will allow an operator to decide whether to re-perform measurements with a source or sensor at a given position, or to perform additional measurements at unforeseen points to increase survey resolution.

It is to be noted that the source signal recordings are not limited to specific activation times. Source seismic waves may have multiple components, each of which can be used to gain information; for example, they can be impulses or amplitude, frequency or phase modulated signals, potentially with varying duty cycles. Sources can even be identified by defining specific waveforms for use by each source. All of this information can be recorded with the corresponding time-stamps for correlation with the received signals.

The present invention allows different surveying techniques to be carried out compared to traditional surveying methods. The arrangement of FIG. 6 applies the present invention to the array type surveying used in the prior art. In this way a series of sensors 20 are set out in a suitable array. Each sensor operates substantially independently to detect signals from a number of satellites 40 to obtain location and time information. The single source 10 also receives signals from the satellites to determine position and time information. The source then operates to generate seismic signals. The precise timing of these signals is recorded and stored in the source device. The transmitted waves are received by the sensors 20 and stored with time stamp and position information. The stored data is subsequently collected and correlated to provide survey data which can be formatted similarly to that shown in FIG. 3.

However, the present invention allows much greater flexibility in the way the sensors and source are operated. As an example, the present invention may be implemented with a configuration using a single source and a single sensor, as shown in FIG. 7. Placing the sensor successively at all the points of a linear 2D array and initiating the source for each sensor position will result in a set of traces on which the absolute time of the sensor initiation and the times of the received signals are recorded and can be read off. Aligning the set of traces using the sensor initiation time as a reference point will allow reproduction of traces similar to those shown in FIG. 3. Again, this allows the use of existing software packages to deduce the subsurface features.

This means that only a single sensor is required and this can be transported to different locations for recording the signals. There is no need for fixed lengths of cable to be prefabricated. The equipment can be easily transported and used by a single person or small team. The source can be preset to provide source signals at regular intervals, so the source can be set up and then left while the user moves the sensor around. Alternatively, the sensor may be set up and the source moved around.

This configuration results in data that is more accurate than current systems, and requires less equipment and setting up. Any extra measurement points desired can be added in real time. A heavy central seismograph with multiple A/D channels, heavy cables and battery charger units are no longer required;

one simple embodiment of the invention could be a portable computer carried in a backpack, using a Wi-Fi connection to one digital GNSS equipped source 10 and one digital GNSS equipped sensor 20.

This arrangement may be more time consuming to collect the data because multiple source actuations would be required and the operator must relocate between readings. However, the set up time is minimal. The operator simply places the source and the sensor for the first reading and can then begin taking readings immediately. Survey operation time can be reduced by increasing the regularity with which the source is initiated. Thus what little if any addition time there is in taking readings should be outweighed by the reduced cost and weight and improved reliability of the system.

There are a number of other advantages of the invention. The operator can place the sensors anywhere and their position can be automatically recorded using the GNSS positioning information, whereas a linear array has to be realigned and possibly surveyed to identify the sensors' locations. Site elevation features can also be taken into account automatically from the GNSS positioning information and so the sensors do not have to be placed on level ground.

With linear arrays the position of sensors is largely defined by the length of the cables and the defined positions of the array. With the present invention, there is provided the flexibility to place sensors according to convenience of the operator and the location and timing is automatically recorded. As a result, there is no need to have to modify the environment to accommodate the survey, e.g. felling trees, earth movements, etc. Surveys can be performed in areas covered in vegetation, without having to clear strips to place arrays. The sensors do not have to be placed exactly at specific points, allowing large objects such as trees, rocks, buildings to be avoided. Surveys can therefore even be performed in residential areas. This means that with the present invention there is a reduced environmental impact and fewer constraints on the surveying.

The invention can be easily integrated with existing sensors and in particular with digital sensors such as MEMS 3C sensors. Existing sensors can be modified by connecting the existing sensor to timing detector and data recording units, for example where the connecting cable would have gone. In this way the output signal is passed to the timing detector unit which then determines the timing information and stores the data, as described above.

The technique of aligning received data traces based upon the source initiation time can be used to increase survey accuracy. Repeating a measurement several times without moving the source or sensor and averaging the results will increase the average signal to noise ratio of the measurement. This requires the improved system accuracy and resolution of the present invention, which is not feasible using current systems. Again, it is a simple matter to take repeat measurements from the same location by simply repeating the source actuation whilst keeping the source and sensor in the same place.

Another advantage is derived from defining the source to provide signals at predetermined intervals. If the sensor is synchronised, it knows roughly when to expect a signal and so it need only ‘listen’ in a window around when the signal is expected. This means that the amount of data collected can be reduced.

Another advantage of the invention lies in monitoring geological or geophysical variations. As stress builds up in the crust of the earth prior to an earthquake, the surrounding rock is compressed. Magma penetration levels below a volcano may change before an eruption. These phenomena will modify the propagation of waves in the subsurface, and cause variations in the speed of propagation. These variations against time can be tracked accurately using the present invention. Leaving sources and sensors in fixed locations in the field and periodically activating the source will provide simple but very accurate measurements of seismic wave propagation time variations that could be used in earthquake or volcanic eruption prediction. A further advantage of the present invention is that the sensor and source do not need to be connected to each other or anything else and the data gathered can be uploaded from them for processing elsewhere.

It should be noted that the invention is equally applicable in off-shore seismographic surveying. However, in this context, it would also be desirable to use the GNSS equipped sources and sensors underwater. However, the signals from GNSS satellites do not propagate through water and cannot be received underwater. A similar problem exists in land surveys where sources and sensors are often located in boreholes to measure downhole and crosshole velocity measurements. Again, the terrain might impose constraints on receiving GNSS signals. For example, in jungles or forests, trees may block out the GNSS signals preventing timing signals being received.

This can be overcome with the present invention by physically separating the GNSS receivers from the sources and/or sensor as required. The GNSS receiver remains on the surface or the earth or on the surface of the sea. It would be connected to the sources and sensors via a fibre-optic cable, allowing the transmission of timing information between receivers and source/sensors. The delay introduced by a fibre-optic cable on timing signals is not zero, but it is effectively constant over a large range of environmental conditions. Traditional metal based cables tend to be more unpredictable than optical fibres due to pressure and temperature dependence.

Adding a fixed length of fibre-optic cable will therefore introduce a fixed delay in the timing signals received by the sources and sensors, which can be corrected by extra data processing functions. Several timing signal synchronisation possibilities exist when using fibre-optic cable. GNSS receivers can generate extremely accurate 1 pulse-per-second (PPS) timing signals. One option is to drive an LED using the 1 PPS timing signals, and transmit the LED signals via the fibre-optic cable to the sources or sensors. The received 1 PPS signal can then drive the source and sensor time-stamping. The technology for this kind of signalling is well known in the communications field where high frequency LED's are used for driving signals into optical fibres.

The delay introduced by the fibre-optic cable can be estimated, calibrated or simply cancelled out using the same length of fibre-optic cable between GNSS equipped sources and sensors. Alternatively, the additional delay can be taken out during processing of the generated signals.

In a configuration with a fixed 1 kilometre loop of fibre-optic cable introduced between a GNSS receiver and the seismic source, the source may be lowered one hundred metres into a borehole. All source timing signals will be delayed by the equivalent of 1 kilometre, regardless of the actual depth of the source in the borehole.

If the receiving sensors are placed on the surface and have no fibre-optic cable between receiver and source, then the sensors will receive an accurate absolute timing signal. When calculating the seismic wave absolute propagation time, the source-side fibre-optic delay has to be subtracted systematically from all receiver sensor time-stamp information.

If the sensors are themselves lowered into a borehole, a 1 kilometre loop of fibre-optic cable can be introduced between the GNSS receivers and the seismic sensors. In this way, both source and sensor timestamps will be offset by exactly the same amount and no corrective processing is required.

Although the description above has been given for terrestrial seismography, the same principles can be used in off-shore surveying. Maritime surveying typically uses a source on board a ship plus towed sensors, although some surveys use sensors laid on the ocean floor. Connecting sources or sensors to GNSS receivers via fibre-optic cables would allow the sources and sensors to be located on or at any height above the ocean floor, while continuing to receive GNSS timing information. The GNSS receiver could be provided in a buoy floating on the surface and connected to the sensor using the optical fibre.

In order to perform seismographic surveys, the present invention will include the following data recording and processing functions:
data communications between sources, sensors and data processing units;
the storage of the source seismic signals programmed for transmission in the case of source trigger signal measurement;
the correlation of received signals and their components with the transmitted signals and components, and identification of matching signals;
filtering out of potential matching signals based on the results of correlation checks between transmitted and received signals;
filtering out of potential matching signals based on source and sensor relative positions, maximum propagation times and transmitted signals;
calculation of the absolute propagation time of each matched signal and component between sources and sensors, using the associated time-stamps;
storage of raw and processed data and results;
preparation and formatting of data and results for further seismographic data processing.

All of the above functions can be realised by adapting currently available software and hardware. For example, signal correlation can be performed using standard software packages or special purpose hardware correlators to increase performance.

Other functions are required to prepare or perform surveys, such as defining source activation times and signals, defining the desired sensor locations, or performing seismographic data processing. These functions exist in current art and can be used without modification in the present invention.

1. A seismographic sensor comprising:
a seismic transducer for receiving seismic signals to produce seismic signal data;
a time signal receiver for obtaining signals comprising time information; and
signal processing means arranged to store said seismic signal data along with time information corresponding to the time at which the seismic signals are received.

2. A seismographic sensor according to claim 1 wherein said time information is related to an absolute global time reference.

3. A seismographic sensor according to claim 1, wherein said time signal receiver is arranged to receive satellite positioning signals and to extract said time information from the received signals.

4. A seismographic sensor according to claim 3 wherein said satellite positioning signals are from a GNSS system.

5. A seismographic sensor according to claim 3, further comprising a position identifier arranged to determine the location of the sensor using the received satellite positioning signals and storing said position information with said seismic signal data and time information.

6. A seismographic sensor according to claim 1, further comprising a communicator arranged to transmit said stored information.

7. A seismographic sensor according to claim 1, wherein the seismic transducer is selected from the group comprising: terrestrial seismic generators and maritime seismic generators.

8. A seismographic sensor according to claim 1, wherein the time signal receiver is located remotely from the seismic transducer.

9. A seismographic sensor according to claim 8 wherein the signal processing means is collocated with said seismic transducer and said time signal receiver is connected to the signal processing means by a communication link.

10. A seismographic sensor according to claim 9 wherein said communication link is a fibre optic cable.

11. A seismography signal source comprising:
a seismic generator for generating seismic signals in a medium;
a time signal receiver for obtaining signals comprising time information; and
signal processing means arranged to store time information corresponding to the time at which the seismic signals were generated.

12. A seismography signal source according to claim 11 wherein said signal processing means is further arranged to store a record of the seismic signals generated.

13. A seismography signal source according to claim 11, wherein said time information is related to an absolute global time reference.

14. A seismography signal source according to claim 11, wherein said time signal receiver is arranged to receive satellite positioning signals and to extract said time information from the received signals.

15. A seismography signal source according to claim 14 wherein said satellite positioning signals are from a GNSS system.

16. A seismography signal source according to claim 14 further comprising a position identifier arranged to determine the location of the sensor using the received satellite positioning signals and storing said position information with said seismic signal data.

17. A seismographic sensor according to any one of claim 11, further comprising a communicator arranged to transmit said stored information.

18. A seismographic sensor according to any one of claim 11, wherein the seismic generator is selected from the group comprising: a thumper and an airgun.

19. A seismographic sensor according to claim 11, wherein the time signal receiver is located remotely from the seismic generator.

20. A seismographic sensor according to claim 19 wherein signal processing means is collocated with said seismic generator and said time signal receiver is connected to the signal processing means by a communication link.

21. A seismographic sensor according to claim 20 wherein said communication link is a fibre optic cable.

22. A seismography data processor comprising a seismic information receiver arranged to receive seismic data from each of a plurality of seismography devices including at least one seismic source and one seismic sensor; and a correlator arranged to:
identify and associate the signals transmitted by the or each seismic source with their corresponding signals received by the or each seismic sensor, based on the signal characteristics and transmitted and received signal times,
calculate the absolute propagation time from each source to each receiver for each associated signal, and
store the calculated propagation time data together with the identification of the corresponding source and receiver pair.

23. A seismography signal processor according to claim 22 wherein said correlator also receives position information for said seismography devices to determine a range of possible propagation times between a source and a sensor; and rejects potential associated signals if the determined transmission time is outside the determined range of possible propagation times.

24. A seismography signal processor according to claim 22, wherein said correlator is arranged to generate and output correlated seismic signal data sets in a predetermined format for further processing.

25. A seismography system comprising at least one seismographic sensor according to claim 1, a seismography signal source comprising:
a seismic generator for generating seismic signals in a medium;
a time signal receiver for obtaining signals comprising time information; and
signal processing means arranged to store time information corresponding to the time at which the seismic signals were generated.

26. A seismography system according to claim 25 further comprising a seismography data processor comprising a seismic information receiver arranged to receive seismic data from each of a plurality of seismography devices including at least one seismic source and one seismic sensor; and a correlator arranged to:
identify and associate the signals transmitted by the or each seismic source with their corresponding signals received by the or each seismic sensor, based on the signal characteristics and transmitted and received signal times,
calculate the absolute propagation time from each source to each receiver for each associated signal, and
store the calculated propagation time data together with the identification of the corresponding source and receiver pair.

27. A method of collecting seismic survey data comprising:
providing, at least at a first location, a seismic signal source including a receiver for receiving time information;
controlling said seismic signal source to generate one or more seismic signals and recording the timing of said seismic signals using said time information;
providing, at least at a second location, a seismic signal detector including a receiver for receiving time information;
obtaining the recorded seismic signals and time information from said seismic signal source;
obtaining from said seismic signal detector, data relating to received seismic signals which are time stamped using said time information;
calculating the absolute propagation time from each seismic signal source to each seismic signal detector;
storing the calculated propagation time data together with the identification of the corresponding seismic signal source and seismic signal detector pair; and
determining at least one of subsurface composition and variations therein, based on the absolute propagation times and variations in absolute propagation times over a period of time, respectively.

28. A method of collecting seismic survey data comprising:
providing, at least at a first location, a seismic signal source including a receiver for receiving time information;
controlling said seismic signal source to generate one or more seismic signals and recording the timing of said seismic signals using said time information;
providing, at least at a second location, a seismic signal detector including a receiver for receiving time information;
obtaining the recorded seismic signals and time information from said seismic signal source;
obtaining from said seismic signal detector, data relating to received seismic signals which are time stamped using said time information;
correlating the recorded seismic signals and time information with said time stamped received seismic signal data to provide said seismic survey data.

29. A method according to claim 28 further comprising:
calculating the absolute propagation time from each seismic signal source to each seismic signal detector and
determining at least one of subsurface composition and variations therein, based on the absolute propagation times and variations in absolute propagation times over a period of time, respectively.

30. A method according to claim 27 wherein said time information is related to an absolute global time reference.

31. A method according to claim 27 wherein said time information is obtained from satellite positioning signals.

32. A method according to claim 31 wherein said satellite positioning signals are from a GNSS system.

33. A method according to claim 31 further comprising determining the location of the seismic signal source and the seismic signal detector using the received satellite positioning signals and storing said position information with said seismic signal data.

34.-37. (canceled)

38. A seismographic sensor comprising:
a seismic transducer adapted to receive seismic signals to produce seismic signal data;
a time signal receiver adapted to obtain signals comprising time information; and
a signal processor arranged to store said seismic signal data along with time information corresponding to the time at which the seismic signals are received.

39. A seismography signal source comprising:
a seismic generator adapted to generate seismic signals in a medium;
a time signal receiver adapted to obtain signals comprising time information; and
a signal processor arranged to store time information corresponding to the time at which the seismic signals were generated.
